(19) United States
(12) Patent Application Publication
(10) Pub. No.: US 2011/0161309 A1
(43) Pub. Date: Jun. 30, 2011

(54) Method Of Sorting The Result Set Of A Search Engine

(75) Inventors: Ka Kui Francois LUNG, Hong Kong (HK); Wai Choi TANG, Hong Kong (HK); Ka Yin Ken LEE, Hong Kong (HK)

(73) Assignee: LX1 TECHNOLOGY LIMITED, Hong Kong (HK)

(21) Appl. No.: 12/648,393

(22) Filed: Dec. 29, 2009

(51) Int. Cl. G06F 17/30

(52) U.S. Cl. 707/709; 707/752; 707/706; 707/E17.058; 707/E17.109

(57) ABSTRACT

A method is disclosed wherein the webpages listed in the result set of a search engine is sorted according to the relevance of the webpages to a list of prioritised search terms. Search terms which are phrases that are delimited by prepositions are considered search terms with high priority. Search terms which nouns are set to high priority. Search terms which are adjectives, verbs, auxiliary verbs, articles, conjunctions, pronouns and prepositions are set to low priority.

### FIELD OF INVENTION

The invention relates to a method for data searching. In particular, the method relates to ordering search results.

### BACKGROUND OF THE INVENTION

Popular Internet search engines, such as Yahoo® and Google® are used to search the Internet for webpages. A user enters one or more keywords into the search engine, which will then search the Internet for webpages having relevance to the keywords.

Each webpage has a set of meta-data, which is a list of keywords set by the author of the webpage and which identifies the topics in the webpage. It is usually the meta-data or other content identifying information that the search engine searches to identify if the webpage is relevant to the user's search.

The search engine then displays the address of the webpages which have meta-data that matches the keywords of the search, in one or more search result pages. Each search result page lists about twenty or so webpage addresses with a short description of each webpage. For some topics, a search would return thousands of webpages, and there could be more than hundreds of search result pages.

The purpose of a search engine is to help the user to narrow down the number of possibly relevant webpages to a manageable number, so that he may find the information he wants easily. However, where the search produces hundreds of search result pages, it is impossible to look at all the thousands of webpages to identify the more relevant ones. In this case, the user is overwhelmed by the abundance of search results.

The skilled man knows that there are other ways of determining the relevance of a webpage to search besides using the meta-data. For example, the search engine can also scan through the entire text within a webpage to see how many of the search terms may be founding the text. Furthermore, the popularity of the webpage (i.e. hit rate), or the number of hyperlinks in other webpages pointing to the webpage (i.e. Google's page rank) may also be used to identify the relevance of the webpage to the search. The details of such strategies are known and need not be discussed in detail here.

Typically, the search result pages list the address of the webpages in the order of the most accessed by other users of the Internet. That is, the webpages which are most accessed by other users in the Internet are placed at the top of the search results, in the first page of the search result pages. If the present user is looking for specific information or for a particular webpage which is not in the first search page, he will have to look in the second, third or fourth pages. However, the natural tendency of most users is to stop looking beyond the second or the third of the search result pages.

One way to overcome this problem is for the user to refine the keywords which were used to perform the search. However, this does not solve all the problems. Where the topic searched on is a popular one, it is inevitable that an overwhelmingly large number of webpages are found by the searched engine, even if the keywords are re-fined to define as narrow a search scope as practicable.

It can be frustrating for the user that the information which he is looking for is continually overwhelmed by popular webpages.

Therefore, it is desirable to provide a way which could improve the relevance of the results in a search engine.

### SUMMARY OF THE INVENTION

The invention provides a method of sorting the result set of a search engine, comprising the steps of obtaining a list of documents from a search engine based a plurality of search terms, prioritising the search terms, sorting the list of documents according to the relevance of each webpage to priority of the search terms, presenting the sorted the list of documents in an order wherein the documents most relevant to the priority of search terms is presented first to the user.

‘Search term’ includes both single words and a plurality of words, such as phrases. ‘Documents’ include webpages, ftp files, PDF documents, text files and any other documents that may be searched in a library or in the Internet.

Therefore, the invention provides the possibility of making a calculated guess to deduce the purpose of the search, so that the documents shown in the search result may be ordered according to the deduced purpose of the user, instead of ordered based on popularity.

Optionally, the search terms are provided in the form of a proper sentence.

Preferably, the method further comprises the steps of setting to lower priority search terms that are adjectives, verbs, auxiliary verbs, articles, conjunctions, pronouns and prepositions, setting to normal priority the remaining search terms that are nouns, and identifying search terms which are delimited by prepositions and setting such preposition-delimited search terms to high priority, wherein the list of documents is sorted according to the relevance of each document to priority of the search terms.

Thus, the invention also provides the possibility of using normal and proper sentences to deduce the purpose of the search, since the sentences is broken down into parts with varying priority. For people who are not familiar with the use of keywords as part of a search strategy, it is advantageous to them to be able to use normal, complete sentences to perform a search which could prioritise the search results based on a breakdown of the sentence.

Advantageously, the invention possibly provides a method which is complementary to existing search engines. This allows optional exploitation of the powers of other complementary technologies as they are developed.

Preferably, the method further comprising the steps of setting to low priority querying pronouns, such as who, whose, whom, what etc., and setting to high priority nouns and names in the search string relating to the pronouns.

Preferably, if the word following a query pronoun is a verb, a noun corresponding to the verb is determined and set to high priority, such as ‘baker’ is set as a high priority keyword from the search string ‘Who could bake a cake?’.

### BRIEF DESCRIPTION OF THE FIGURES

It will be convenient to further describe the present invention with respect to the accompanying drawings that illustrate possible arrangements of the invention, in which like reference numbers refer to like parts. Other arrangements of the invention are possible, and consequently the particularity of the accompanying drawings is not to be understood as superseding the generality of the preceding description of the invention, wherein:

FIG. 1 is a schematic diagram of a first embodiment of the invention;

FIG. 2 illustrates a complementary search interface in the embodiment of FIG. 1;

FIG. 3 is a flowchart of the functions in the embodiment of FIG. 1;

FIG. 4 is a schematic diagram of the hardware used by the embodiment of FIG. 1;

FIG. 5 illustrates a particular step in the flowchart of FIG. 3; and

FIG. 6 is a flowchart of a variation of the embodiment illustrated in FIG. 3.

### DETAILED DESCRIPTION OF THE INVENTION

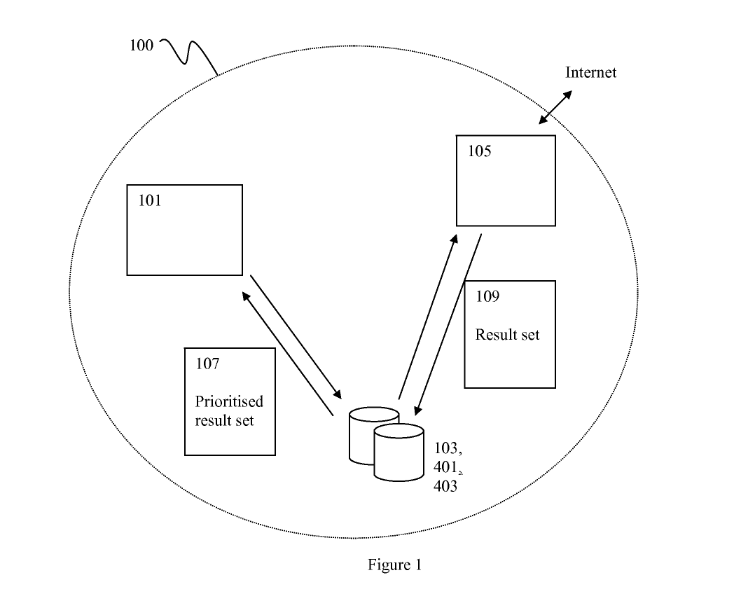

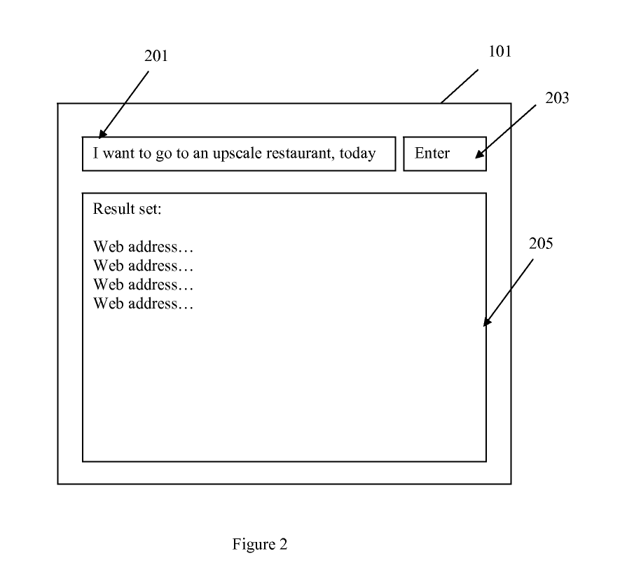

FIG. 1 is a schematic diagram showing how a first embodiment of the invention works. The embodiment resides in a computer 100 belonging to a user of the embodiment. The embodiment comprises a complementary search interface 101 installed in the computer of the user. FIG. 2 shows an illustration of the complementary search interface 101. The complementary search interface 101 has a textbox 201 for a search string, into which a user can enter a search string “I want to go to an upscale restaurant for dinner, today.”. After that, when the user presses the ‘Enter’ button 203, a processor in the computer receives the search string from the complementary search engine 101 and sends the search string to a known search engine 105 that is connected to the Internet, such as that of Yahoo® and Google®. The skilled man understands the technologies which are used to trigger and activate the known search engines to initiate a search and it is not necessary to explain this in detail here.

Accordingly, a search engine result set 109 of the web address of relevant web pages is obtained. The web addresses are typically ordered such that the most accessed webpage are placed at the top of the list.

The search engine result set 109 is then taken by the processor to re-order the list of webpage addresses from the most relevant to the least relevant to the search string.

‘Relevance’ of a webpage is deduced by identifying which words, or phrases, in the search string are more significant than the others. Thus, the webpages identified in the search engine result set 109 are re-ordered according to their relevance to the significance of the words and displayed in the result box 205 of the complementary search interface 101.

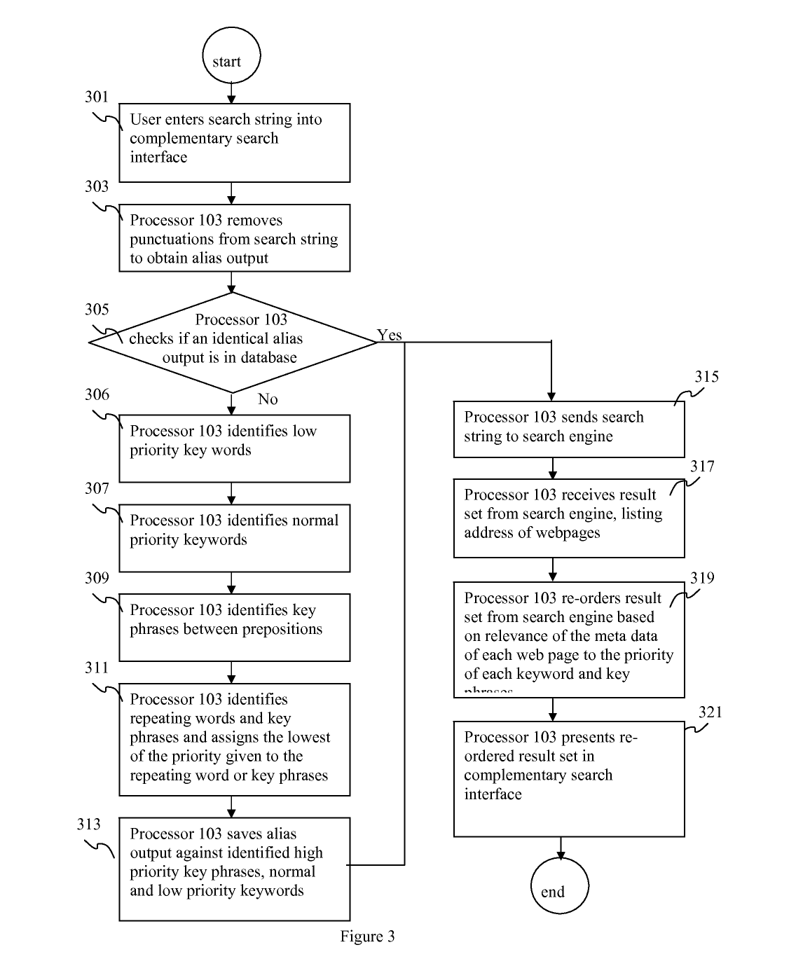

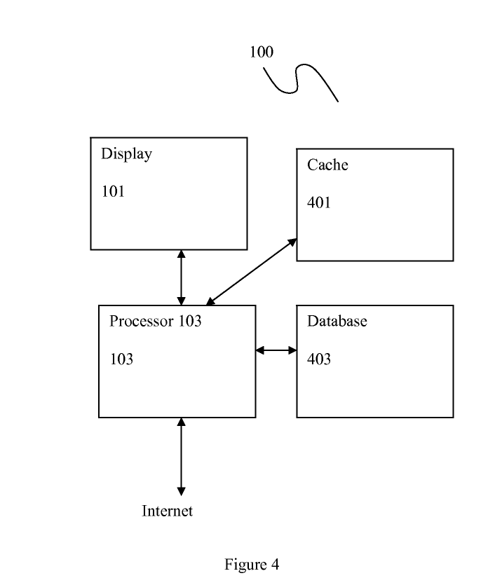

FIG. 3 is flowchart of the process, in which the search string is processed to identify the more significant words in the search string. FIG. 4 shows some of the components in the computer 100 which interact to realise the steps of the flowchart. It is to be noted that the components shown in FIG. 4 are for the purpose of describing the embodiment and is not supposed to show all the components in any computer.

Firstly, the user enters the search string “I want to go to an upscale restaurant for dinner, today.” into the search textbox in the complementary search interface, at step 301. Then, punctuations in the search string are removed, at step 303. The remaining spaces are retained as delimiters. Thus, “I want to go to an upscale restaurant for dinner, today.” becomes “I want to go to an upscale restaurant for dinner today” (full-stop removed). The punctuation removed sentence is known herein as an ‘alias output’.

At this stage, the processor 103 compares the alias output to see if there is already an identical one saved in a database 403, at step 305. If not, the following types of words in the alias output are immediately given low priority, at step 306:
all verbs;
all adjectives.
auxiliary verbs such as ‘have’, ‘can’, ‘will’, ‘shall’, ‘would’ ‘should’ and ‘be’;
prepositions, such as ‘at’, ‘in’, ‘on’, ‘about’, ‘during’, ‘over’, ‘by’, ‘to’, ‘into’, ‘from’, ‘with’;
definite and indefinite articles such as ‘a’, ‘an’, ‘the’;
conjunctions such as ‘and’, ‘or’, ‘where’, ‘whom’ are also given low priority.
adverbs and pronouns for enquiry such as ‘who’, ‘what’, ‘when’, ‘where’, ‘how’, ‘which’, ‘whose’ are also given low priority (more on these query adverbs and pronouns will be discussed later).

The skilled man understands that conjugations of the infinitive verbs are treated as the infinitive verbs themselves. Thus, ‘is’, ‘was’, ‘are’, were’ and ‘am’ are treated in the same way as ‘be’.

Thus, in the search string, the pronoun “I” is given low priority. Similarly, verbs “want” and “go”, and the article and preposition “an” and “for” are given low priority.

The remaining words “restaurant”, “today” are given normal priority, at step 307. These are typically nouns.

Subsequently, ‘key-phrases’ are identified from the entire sentence as delimited by prepositions. Thus, “I want to go to an upscale restaurant for dinner today” gives the key-phrases, “I want”, “go”, “an upscale restaurant”, “dinner today”. All the key-phrases are given high priority, at step 309.

The processor 103 then checks all the key phrases and key words to identify repetitions. For example, “go” has already been given a low priority and in the preceding steps and simply ignores “go” as a key-phrase. If there are two or more instances of a word in the search string, and the instances of the word have different priorities, the lower of the priority is selected as the priority of the word, at step 311 so that there are less competition for priority, thus further streamlining the re-ordering of the search result.

The key-phrases and the words that have been given their priority are entered into a database 403 according to their priority, which is illustrated in Table 1 as follows:

TABLE 1

| | Key phrases | Normal | Low |
|---|---|---|---|
| Alias output | (top priority) | priority | priority |
| I want to go to an | I want | restaurant | I |
| upscale restaurant | | | |
| for dinner today | | | |
| | an upscale | today | want |
| | restaurant | | |
| | dinner today | | to |
| | | | go |
| | | | an |
| | | | for |
| | | | upscale |

Note that the two instances of ‘to’ are combined as one.

The database 403 therefore stores the prioritised keywords against an ‘alias output’, at step 313. There are three key-phrases, two normal priority keywords and seven low priority key words listed against the alias output.

The processor 103 then sends the search string to a known web search engine, at step 315, such as Yahoo® and Google® and obtains the search engine result from the search engine, at step 317. The search result from the search engine is stored in the cache memory 401 of the computer for further processing.

Then the processor 103 goes through the meta-data or the contents of the webpages listed in the search engine results to order the webpages according to their relevance to the key phrases and key words in order of the priority assigned, as shown in Table 1, at step 319. The search engine results, i.e. the list of the webpage addresses, are stored in the cache memory 401 in the computer. The processor 103 thus looks in the search engine results for those webpage addresses that have meta-data which are relevant to the high priority key-phrases stored in the database 403. The description, title and URL of these webpages are taken and placed at the top of a new, re-ordered search result 107, which is also temporarily stored in the cache. Then the processor 103 then goes through the remaining webpages in the search engine result 109 to look for those which are relevant to the normal priority key words. The webpages relevant to the normal priority key words are placed after the webpages which are relevant to the high priority key-phrases in the cache memory 401. Then the processor 103 then goes through the yet remaining webpages to look for those webpages which are relevant to the low priority key words. The webpages which are relevant to the low priority key words are placed after the webpages which are relevant to the normal priority key words, in the cache memory 401. The remaining webpages in the search engine result set 109 are placed after the webpages which are relevant to the low priority key words, in the cache memory 401.

Optionally, the processor 103 goes though the webpage meta-data compares the meta-data with the prioritised keywords in the cache. Alternatively, the processor 103 goes though the text of the webpage and compares the webpage highlights against the prioritised keywords in the cache. The webpage ‘highlight’ is the descriptive portion one usually sees trailing the titles of the webpages in a Yahoo® and Google® search result.

The webpages with the most “matched” prioritised keywords will be given higher priorities than the remaining ones. This means that the webpages with the highest number of words or phrases matching the words and phrases in the high and normal priority will be considered the more relevant webpages.

To further distinguish the relevant webpages, the processor 103 will also check the order of keywords in the webpages. Those with the exact match of word sequence will go to the top of the search results. For example, if the search string includes the phrase ‘an upscale restaurant’, the webpage with the phrase ‘an upscale restaurant’ will be placed higher than the webpage with the phrase ‘a restaurant which is upscale’.

The re-ordered result set 107 in the cache memory 401, which is now prioritised according to the priority as discussed for Table 1 is obtained from the cache is displayed to the user, at step 321, by the complementary search interface 101.

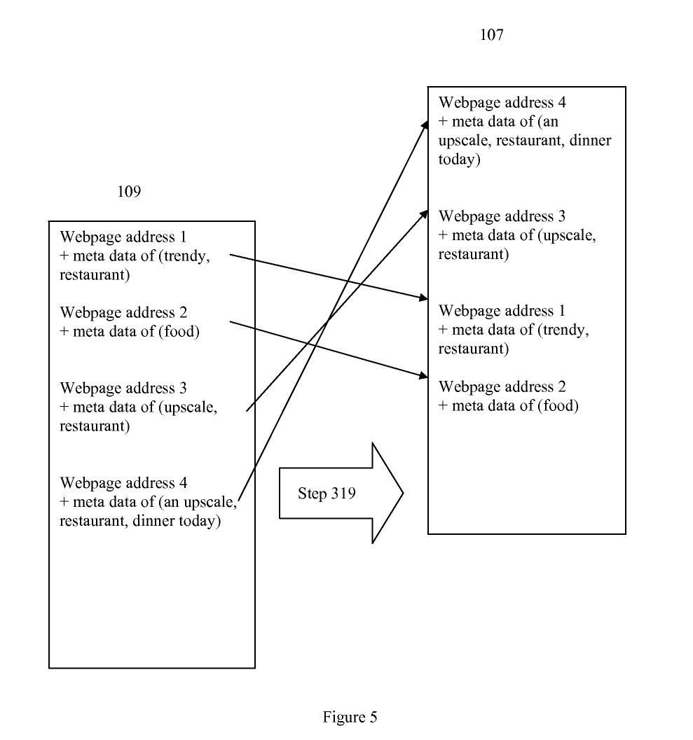

FIG. 5 illustrates how the meta-data and/or content of the webpages listed in the search engine result set 109 leads to their re-ordering in a re-ordered, prioritised result set 107, at step 319. The webpages 1, 2, 3 and 4 are re-ordered to webpages 4, 3, 1, 2 by the relevance of their meta-data to the priority of the key phrases and keywords in Table 1.

The skilled man understands that it is optional whether the process of FIG. 3 downloads the search result of the search engine first, that is, performs steps 315 and 371 before step 303.

As shown in FIG. 1, the database resides in the user's personal computer. Thus, every time the user searches for the same information using the same search string, there is no need to repeat the entire process of identifying the priority of the keywords and key-phrases in the sentence. The processor 103 need only check if the search string removed of punctuation marks matches an alias output, at step 305. If so, the processor 103 will simply send the search string to the search engine 105, at step 315, and re-order the returned results, at steps 317, 319, according to the priority of the key-words and the key-phrases listed against the alias output.

Thus, the embodiment comprises a method of sorting the result set of a search engine, comprising the steps of obtaining a list of documents from a search engine based a plurality of search terms, prioritising the search terms, sorting the list of documents according to the relevance of each webpage to priority of the search terms, presenting the sorted the list of documents in an order wherein the documents most relevant to the priority of search terms is presented first to the user. ‘Search terms’ can be a single word or several words, as in the key phrases.

Key phrases are therefore search terms which are delimited by prepositions. The skilled man knows that in a sentence like “I want to go to an upscale restaurant, today.”, where the sentence does not begin nor end with a preposition, the first key-phrases is the first phrase that ends with the first proposition in the sentence, i.e. the first ‘to’. Similarly, the skilled man knows that the last key-phrase is the last phrase in the search string that begins with the last proposition in the sentence, i.e. the second ‘to’.

As another example, the search string “All food cheap and healthy to buy this Christmas!” provides the priority search terms shown in Table 2.

TABLE 2

| | Key phrases | Normal | Low |
|---|---|---|---|
| Alias output | (high priority) | priority | priority |
| All food cheap and | All food cheap | All | and |
| healthy to buy this | | | |
| Christmas | | | |
| | healthy | food | to |
| | buy this | Christmas | buy |
| | Christmas | | |
| | | | this |
| | | | healthy |
| | | | cheap |

The key phrases are obtained as delimited by ‘and’ and ‘to’. Conjunctions and adjectives such as ‘and’, ‘to’, ‘buy’, ‘this’, ‘healthy’ and ‘cheap’ are given low priority, whereas the nouns ‘all’, ‘food’ and ‘Christmas’ are given normal priority. The key phrases are given high priority.

As another example, the search string “How to take care of your sick pets, in the absence of a vet?” provides the priority search terms shown in Table 3.

TABLE 3

| | Key phrases | Normal | Low |
|---|---|---|---|
| Alias output | (high priority) | priority | priority |
| How to take care of | How | care | How |
| your sick pets in the | | | |
| absence of a vet | | | |
| | take care | pets | to |
| | your sick pets | absence | take |
| | the absence | vet | of |
| | a vet | | your |
| | | | in |
| | | | the |
| | | | of |
| | | | a |
| | | | sick |

The key phrases are obtained as delimited by ‘to’. ‘of’ and ‘in’. Conjunctions and adjectives such as ‘how’, ‘to’, ‘take’, ‘of’, ‘your’, ‘in’, ‘the’, ‘of’, ‘a’ and ‘sick’ are given low priority, whereas the nouns ‘care’, ‘pets’, ‘absence’, ‘vet’ are given normal priority. The key phrases are given high priority.

As another example, the search string “How to go to Detroit to LA” provides the priority search terms shown in Table 4.

TABLE 4

| | Key phrases | Normal | Low |
|---|---|---|---|
| Alias output | (high priority) | priority | priority |
| How to go to | How | go | to |
| Detroit to LA | | | |
| | Detriot | | |
| | LA | | |

If there is a conjunction in the search string, such as ‘and’ and ‘or’, the whole search string would still be broken down in the same way, as the conjunctions are simply considered delimiters between two search strings. Thus, a search string ‘How to go to Detroit to LA and take care of your sick pets in the absence of a vet’ will simply prioritise the search string as in Tables 3 and 4 combined.

Preferably, in order for the processor 103 to distinguish the category of each word in the search string, there is a table in the database 403 classifying words into nouns, verbs, names. Table 5 illustrates an example of the content of such a table.

TABLE 5

| Word | Name | Verb | Noun | Adjective | Etc |
|---|---|---|---|---|---|
| Tower | Yes | No | Yes | No | |
| Running | No | Yes | No | Yes | |
| Peter | Yes | No | No | No | |
| Apple | No | No | Yes | No | |
| Etc. | | | | | |

Further variations of the embodiment will now be described.

In a variation of the described embodiment, adverbs relating to query, such as ‘when’, ‘how’, and pronouns relating to query, such as ‘who’, ‘what’, ‘where’, ‘which’, ‘whose’ are identified and used to set the context of the search. In other words, these query adverbs and pronouns adjust the above-described priority of the other words in the search string.

For example, if the search string has the query adverb ‘how’ in it, it implies that the search relates to how to get certain things done, i.e. an action. Thus, verbs in the search string following the word ‘how’ are given high priority. Otherwise, the verbs are given low priority, as discussed above. For example, in ‘How to bake a cake’, the priority of word ‘bake’ is changed from low to high priority, since ‘bake’ follows ‘how’.

In the same way, if the search string has the pronoun ‘where’ in it, nouns and names following the word ‘where’ in the search string are given high priority. Otherwise, names, which are usually nouns, remains under normal priority. For example, in ‘Where is a restaurant which serves whale meat’, the priority of the word ‘restaurant’ is changed from normal to high priority.

In yet a further variation of the embodiment, the text in the search string is also changed automatically based on these query words. For example, in the case where a verb follows a query pronoun (who, what etc) instead of an adverb (how, why etc.) in the search string, such as ‘Who could bake a cake?’, the processor 103 identifies that the verb ‘bake’ following the pronoun ‘who’ is a verb-pronoun mismatch. Thus, the processor 103 searches for a noun corresponding to the verb ‘bake’ from a table in the database 403 and finds ‘baker’. ‘Baker’ is then given top priority in the search. Thus, the processor 103 is able to link the noun ‘baker’ to the ‘who’ query, and then searches for ‘baker’ instead of ‘bake’ in the meta-data and/or the text of the webpages. An example of such a table is shown as Table 6.

TABLE 6

| Noun | Pronoun | Verb | Adverb | Noun | Pronoun |
|---|---|---|---|---|---|
| Baker | Who | Bake, | How, Why | | |
| | | baking | | | |
| Runner | Who | Run, | How, Why | | |
| | | running | | | |
| Parisian | Who | | | Paris | Where |

Table 6 shows how a verb may be linked to a noun, the query pronouns and the query adverbs. Besides showing that the word ‘baker’ is a noun corresponding to the verb ‘bake’, Table 6 also shows that ‘baker’ is linked to the querying pronoun ‘who’. Furthermore, the verb ‘bake’ or its variations such as ‘baking’ are linked to the querying adverbs ‘how’ and ‘why’.

Table 6 also gives an example of how the noun ‘runner’ is linked to a pronoun ‘who’, and is linked to the verb ‘run’ which is in turn linked to the adverbs ‘how’ and ‘why’.

Table 6 also shows that the word ‘Paris’ is a name of a place, also a noun, which is liked to the querying pronoun ‘where’. However, ‘Parisian’ also has an entry as a second, related noun, which is liked to the place ‘Paris’ and the pronoun ‘who’.

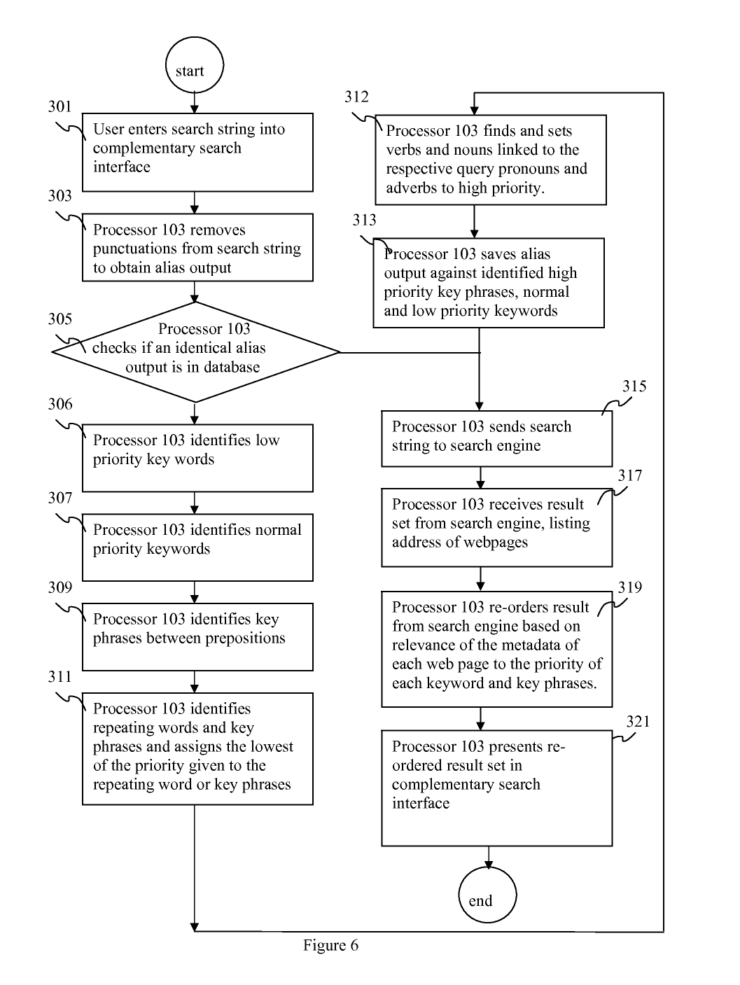

FIG. 6 illustrates the steps in the process wherein the query words, such as adverbs and pronouns, ‘which’, ‘where’, ‘when’, ‘how’, ‘why’ are used to adjust the priority of some words, at step 312, in addition to the steps shown in FIG. 3. That is, at step 312, the processor 103 identifies querying pronouns and adverbs, and automatically set verbs and nouns linked to these words to high priority.

In yet another variation of the embodiment, the embodiment comprises a database of identifying the contexts of query phrases. For example, the database classifies ‘how much’ as linked to quantity such like ‘prices’ and ‘time’. Thus, if the search string has the clause ‘how much’, webpages containing the words ‘time’ and prices' or their units in word or signs such as ‘$’, ‘dollars’, ‘yen’, ‘euro’ are placed higher in priority.

In yet a further variation of the embodiments, the complementary search interface 101 need not be complementary to a web search engine. Any other search engines, such as a library catalogue program or an academic paper search engine may be complemented by the complementary search interface 101. In this case, the search result lists any other type of documents other than webpages. It is also possible that the relevance of the documents or webpages is not stored as meta-data but in some other form of keyword identifying structure.

In yet a further variation of the embodiments, where there are different conjugations of a word, the skilled man understands that a database can be built to identify the infinitive form and the other conjugations of the word. This is already known in the art and needs no detail description here.

In another variation of the embodiment, the default priority of adjectives and/or verbs is changed from low to normal or to high priority. This depends on specific implementations of the embodiment. For example, if the embodiment is specifically implemented for searching information on visual arts, adjectives are particularly useful in describing the visual arts.

Accordingly, the embodiments described includes a method of sorting the result set of a search engine, comprising the steps of obtaining a list of documents from a search engine based a plurality of search terms, prioritising the search terms, sorting the list of documents according to the relevance of each webpage to priority of the search terms, presenting the sorted the list of documents in an order wherein the documents most relevant to the priority of search terms is presented first to the user.

Preferably, the method further comprises the steps of setting to high priority the verbs in the search string relating to querying adverbs, such as ‘why’, ‘how’ etc.

Preferably, the method further comprises the steps of setting to high priority nouns and names in the search string relating to querying pronouns such as ‘where’ and ‘who’.

Preferably, if there is a pronoun-verb mismatch, or an adverb-noun mismatch in the search string, a suitable word is used to replace the mismatching noun or verb. For example, if the word following a query pronoun is a verb, a noun corresponding to the verb is determined and set to high priority, such as ‘baker’ is set as a high priority keyword based on the search string ‘Who could bake a cake?’. Similarly, if the query adverb is followed by a noun, such as ‘How does a baker bake?’, the adverb-noun mismatch of ‘how’ and ‘baker’ causes the embodiment to look for a verb corresponding to the noun ‘baker’, which is ‘bake’, and setting ‘bake’ to high priority.

Advantageously, the embodiment described narrows down the possibility and context and promotes greater accuracy in the search results. However, the skilled man understands that it is not possible that the embodiments are able to address all the possible contextual variations in any language. Thus, where the embodiment is unable to decipher the context of a complex search string, the usual search result as used by the typical search engines such as Yahoo® and Google® will be displayed. Preferably, however, actual implementations of the embodiments are able to breakdown sentences and questions which are at the level of complexity of the language of an 8 year-old child.

While there has been described in the foregoing description preferred embodiments of the present invention, it will be understood by those skilled in the technology concerned that many variations or modifications in details of design, construction or operation may be made without departing from the scope of the present invention as claimed.

1. A method of sorting the result set of a search engine, comprising the steps of obtaining a list of documents from a search engine based a plurality of search terms;
prioritising the search terms;
sorting the list of documents according to the relevance of each webpage to priority of the search terms;
presenting the sorted the list of documents in an order wherein the documents most relevant to the priority of search terms is presented first to the user.

2. A method of sorting the result set of a search engine, as claimed in claim 1 wherein the search terms are provided in the form of a proper sentence.

3. A method of sorting the result set of a search engine, as claimed in claim 2 further comprising the steps of
setting to low priority search terms that are adjectives, verbs, auxiliary verbs, articles, conjunctions, pronouns and prepositions;
setting to normal priority the remaining search terms that are nouns,
and
identifying search terms which are delimited by prepositions and setting such preposition-delimited search terms to high priority; wherein
the list of documents is sorted according to the relevance of each document to priority of the search terms.

4. A method of sorting the result set of a search engine, as claimed in claim 2 further comprising the steps of
setting to low priority querying adverbs; and
setting to high priority verbs in the search string relating to the adverbs.

5. A method of sorting the result set of a search engine, as claimed in claim 3 further comprising the steps of
setting to low priority querying adverbs; and
setting to high priority verbs in the search string relating to the adverbs.

6. A method of sorting the result set of a search engine, as claimed in claim 2 further comprising the steps of
setting to low priority querying pronouns; and
setting to high priority nouns in the search string relating to the pronouns.

7. A method of sorting the result set of a search engine, as claimed in claim 4, wherein
if the word following a query pronoun is a verb, a noun corresponding to the verb is determined and set to high priority.

8. A method of sorting the result set of a search engine, as claimed in claim 5, wherein
if the word following a query pronoun is a verb, a noun corresponding to the verb is determined and set to high priority.

9. A method of sorting the result set of a search engine, as claimed in claim 4, wherein
if the word following a query adverb is a noun, a verb corresponding to the noun is determined and set to high priority.

10. A method of sorting the result set of a search engine, as claimed in claim 5, wherein
if the word following a query adverb is a noun, a verb corresponding to the noun is determined and set to high priority.
